(19) United States
(12) Patent Application Publication
(10) Pub. No.: US 2021/0089423 A1
(43) Pub. Date: Mar. 25, 2021

(54) FLEXIBLE MULTI-USER GRAPHICS ARCHITECTURE

(71) Applicant: Advanced Micro Devices, Inc., Santa Clara, CA (US)

(72) Inventors: Ruijin Wu, San Diego, CA (US); Skyler Jonathon Saleh, San Diego, CA (US); Vineet Goel, San Diego, CA (US)

(73) Assignee: Advanced Micro Devices, Inc., Santa Clara, CA (US)

(21) Appl. No.: 16/913,562

(22) Filed: Jun. 26, 2020

Related U.S. Application Data
(60) Provisional application No. 62/905,010, filed on Sep. 24, 2019.

(51) Int. Cl. G06F 11/34; G06F 9/54; G06F 15/82

(52) U.S. Cl. CPC G06F 11/3409; G06F 15/82; G06F 9/542

(57) ABSTRACT

A technique for operating a processor that includes multiple cores is provided. The technique includes determining a number of active applications, selecting a processor configuration for the processor based on the number of active applications, configuring the processor according to the selected processor configuration, and executing the active applications with the configured processor.

### CROSS-REFERENCE TO RELATED APPLICATIONS

This application claims priority to pending U.S. Provisional Patent Application No. 62/905,010, entitled “FLEXIBLE MULTI-USER GRAPHICS ARCHITECTURE,” and filed on Sep. 24, 2019, the entirety of which is hereby incorporated herein by reference.

### BACKGROUND

Graphics processing hardware accelerates graphics rendering tasks for applications. Server-size hardware-based rendering is becoming increasingly common and improvements to such rendering are frequently being made.

### BRIEF DESCRIPTION OF THE DRAWINGS

A more detailed understanding can be had from the following description, given by way of example in conjunction with the accompanying drawings wherein:

FIG. 1A is a block diagram of a cloud gaming system, according to an example;

FIG. 1B is a block diagram of an example device in which one or more features of the disclosure can be implemented;

FIG. 1C illustrates additional details of the server, according to an example;

FIG. 2 is a block diagram illustrating details of a graphics core, according to an example;

FIG. 3 is a block diagram showing additional details of the graphics processing pipeline illustrated in FIG. 2; and

FIG. 4 is a flow diagram of a method for operating a graphics processor with multiple graphics cores, according to an example.

### DETAILED DESCRIPTION

A technique for operating a processor that includes multiple cores is provided. The technique includes determining a number of active applications, selecting a processor configuration for the processor based on the number of active applications, configuring the processor according to the selected processor configuration, and executing the active applications with the configured processor.

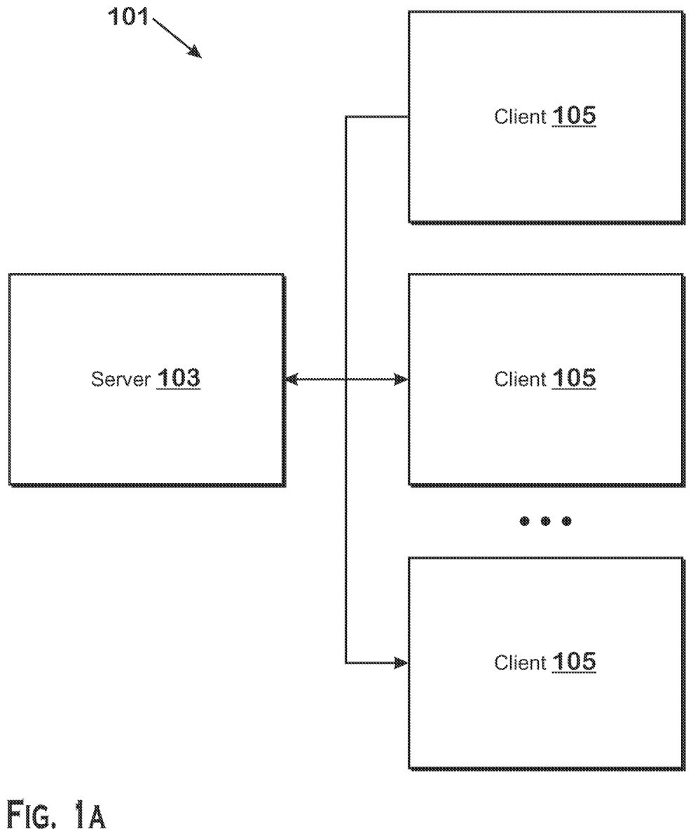

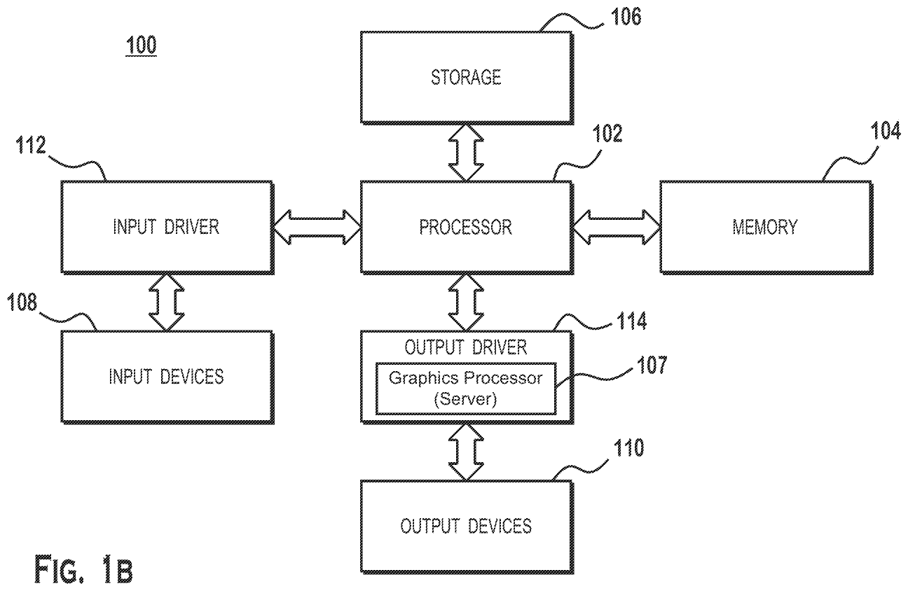

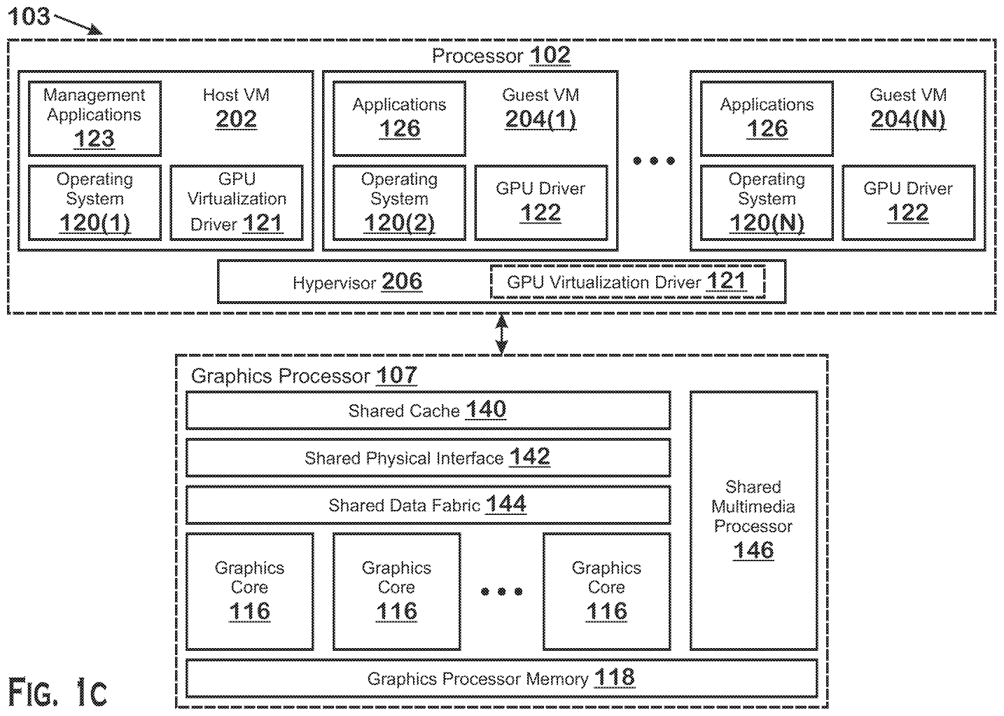

FIG. 1A is a block diagram of a cloud gaming system 101, according to an example. A server 103 communicates with one or more clients 105. The server 103 executes gaming applications at least partly using graphics hardware. The server 103 receives inputs from the one or more clients 105, such as button presses, mouse movements, and the like. The server 103 provides these inputs to the applications executing on the server 103, which processes the inputs and generates video data for transmission to the clients 105. The server 103 transmits this video data to the clients 105 for display and the clients 105 display the video data.

FIG. 1B is a block diagram of an example device 100 in which one or more features of the disclosure can be implemented. In various implementations, the server 103 and/or client 105 of FIG. 1A are implemented as the device 100. In the server, a graphics processor 107 is included. In different implementations, the clients 105 do or do not include the graphics processor 107. In various implementations, the device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 can include additional components not shown in FIG. 1B.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is be located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes a graphics processor 107. The graphics processor 107 is configured to accept graphics rendering commands from processor 102, to process those compute and graphics rendering commands, and to provide pixel output to a display device for display.

FIG. 1C illustrates additional details of the server 103, according to an example. The processor 102 is configured to support a virtualization scheme in which multiple virtual machines execute on the processor 102. Each virtual machine (“VM”) “appears” to software executing in that VM as a completely “real” hardware computer system, but in reality comprises a virtualized computing environment that may be sharing the device 100 with other virtual machines. Virtualization may be supported fully in software, partially in hardware and partially in software, or fully in hardware. The graphics processor 107 supports virtualization, meaning that the graphics processor 107 can be shared among multiple virtual machines executing on the processor 102, with each VM “believing” that the VM has full ownership of a real hardware graphics processor 107. The graphics processor 107 supports virtualization by assigning a different graphics core 116 of the graphics processor 107 to each active guest VM 204. Each graphics core 116 performs graphics operations for the associated guest VM 204 and not for any other guest VM 204.

The processor 102 supports multiple virtual machines, including one or more guest VMs 204 and, in some implementations, a host VM 202. The host VM 202 performs one or more aspects related to managing virtualization of the graphics processor 107 for the guest VMs 204. A hypervisor 206 provides virtualization support for the virtual machines, by performing a wide variety of functions such as managing resources assigned to the virtual machines, spawning and killing virtual machines, handling system calls, managing access to peripheral devices, managing memory and page tables, and various other functions. In some implementations, the host VM 202 provides an interface for an administrator or administrative software to control configuration operations of the graphics processor 107 related to virtualization. In some systems, the host VM 202 is not present, with the functions of the host VM 202 described herein performed by the hypervisor 206 instead (which is why the GPU virtualization driver 121 is illustrated in dotted lines in the hypervisor 206).

The host VM 202 and the guest VMs 204 have operating systems 120. The host VM 202 has management applications 123 and a GPU virtualization driver 121. The guest VMs 204 have applications 126, an operating system 120, and a GPU driver 122. These elements control various features of the operation of the processor 102 and the graphics processor 107.

The GPU virtualization driver 121 of the host VM 202 is not a traditional graphics driver that simply communicates with and sends graphics rendering (or other) commands to the graphics processor 107, without understanding aspects of virtualization of the graphics processor 107. Instead, the GPU virtualization driver 121 communicates with the graphics processor 107 to configure various aspects of the graphics processor 107 for virtualization. In some examples, in addition to performing the configuration functions, the GPU virtualization driver 121 issues traditional graphics rendering commands to the graphics processor 107 or other commands not directly related to configuration of the graphics processor 107.

The guest VMs 204 include an operating system 120, a GPU driver 122, and applications 126. The operating system 120 is any type of operating system that could execute on processor 102. The GPU driver 122 is a “native” driver for the graphics processor 107 in that the GPU driver 122 controls operation of the graphics processor 107 for the guest VM 204 on which the GPU driver 122 is running, sending tasks such as graphics rendering tasks or other work to the graphics processor 107 for processing. The native driver may be an unmodified or slightly modified version of a device driver for a GPU that would exist in a bare-bones non-virtualized computing system.

Although the GPU virtualization driver 121 is described as being included within the host VM 202, in other implementations, the GPU virtualization driver 121 is included in the hypervisor instead 206. In such implementations, the host VM 202 may not exist and functionality of the host VM 202 may be performed by the hypervisor 206.

The operating systems 120 of the host VM 202 and the guest VMs 204 perform standard functionality for operating systems in a virtualized environment, such as communicating with hardware, managing resources and a file system, managing virtual memory, managing a network stack, and many other functions. The GPU driver 122 controls operation of the graphics processor 107 for any particular guest VM 204 by, for example, providing an application programming interface (“API”) to software (e.g., applications 126) to access various functionality of the graphics processor 107. In some implementations, the driver 122 also includes a just-in-time compiler that compiles programs for execution by processing components (such as the SIMD units 138 discussed in further detail below) of the graphics core 116. For any particular guest VM 204, the GPU driver 122 controls functionality on the graphics core 116 related to that guest VM 204, and not for other VMs.

The graphics processor 107 includes multiple graphics cores 116, a shared data fabric 144, a shared physical interface 142, a shared cache 140, a shared multimedia processor 146, and a shared graphics processor memory 118.

The graphics cores 116 of the graphics processor 107 are individually assignable to different guest VMs 204. More specifically, the GPU virtualization driver 121 assigns a physical graphics core 116 exclusively to a particular guest VM 204 for use in performing processing tasks such as graphics processing and compute processing.

The shared multimedia processor 146, graphics processor memory 118, shared cache 140, shared physical interface 142, and shared data fabric 144 are all shareable between the different graphics cores.

The graphics processor memory 118 includes multiple memory portions. In some configurations, the graphics processor memory 118 is divided into portions, each of which is assigned to a different graphics core 116. In such configurations, the GPU virtualization driver 121 assigns particular portions of the graphics processor memory 118 to particular graphics cores 116. In such configurations, a graphics core 116 is able to access portions of the graphics processor memory 118 that are assigned to that graphics core 116 and a graphics core 116 is unable to access portions of the graphics processor memory 118 that are not assigned to that graphics core 116. In some implementations, the portions that are assignable to different graphics cores 116 are physical subdivisions of the graphics processing memory 118, such as specific memory banks. In some implementations, more than one portion of memory is assigned to a single graphics core 116. In some implementations, all (or multiple) graphics cores 116

The shared cache 140 is shareable in that different graphics cores 116 are able to cache data in any portion of the shared cache 140. In alternative implementations, however, the shared cache 140 is configured differently. More specifically, in one implementation, the cache 140 is partitioned into portions and each portion is assigned to a graphics core 116 (e.g., for exclusive use). In another implementation, the entire cache 140 is shared between the graphics cores 116 to reduce external memory traffic if the graphics cores 116 access the same data. The shared physical interface 142 is an input/output interface to components external to the graphics processor 107. The shared physical interface 142 is shareable between the graphics cores 116 in that the shared physical interface 142 is capable of routing data and commands for each graphics core 116 to components external to the graphics processor 107. The shared data fabric 114 routes memory transactions between the graphics cores 116 and the graphics processor memory 118. The shared data fabric 114 is shareable between the different graphics cores 116 in that each graphics core 116 interfaces with the shared data fabric 114 to access the portions of the graphics processor memory 118 assigned to that graphics core 116.

In various configurations, the graphics cores 116 are operable at different performance levels. In some implementations, one or more of the graphics cores 116 differs from one or more of the other graphics cores 116 in terms of the number of resources physically present within that graphics core. In some examples, these resources include one or more of amount of memory, amount of cache memory, and/or number of compute units 134.

In some examples, the graphics cores 116 are switchable between different performance levels at runtime. In some implementations, each graphics core 116 has an adjustable performance level in terms of one or more of clock speed, or number of components enabled. In some implementations, a higher clock speed applied to a graphics core 116 or a higher number of components enabled for a graphics core 116 results in a greater power usage for the graphics core 116 and/or a greater amount of heat dissipation for the graphics core 116. In general, a higher performance level for a graphics core 116 is associated with a higher amount of power usage and heat dissipation.

In some examples, the hypervisor 206 configures the device 103 for use by a certain number of active guest VMs 204. Depending on the number of guest VMs 204 that are active and the performance requirements of the guest VM 204, the hypervisor 206 configures the performance levels of the different graphics cores 116. In some implementations, the hypervisor 206 identifies a power budget and a thermal budget for the graphics processor 107 overall and sets the performance levels of the enabled graphics cores 116 based on the total power budget and the total thermal budget. Thus, in some implementations, in situations where more guest VMs 204 are enabled, the hypervisor 206 sets the performance levels of one or more graphics cores 116 to a lower performance level than in situations where fewer guest VMs 204 are enabled.

In some implementations, the graphics processor 107 is switchable between a set of a fixed number of configurations. Each such configuration indicates a number of graphics cores 116 that are enabled and indicates a specific performance level for each enabled graphics core 116.

In some implementations, the set of fixed configurations includes at least one configuration in which a first graphics core 116 is enabled and a second graphics core 116 is disabled and another configuration in which the first graphics core 116 and the second graphics core 116 are both enabled, where in the first configuration, the first graphics core has a higher performance level than the first graphics core in the second configuration.

The graphics processor memory 118 has a certain amount of bandwidth to the graphics cores 116. In configurations in which multiple graphics cores 116 are enabled, the bandwidth is divided between the different graphics cores 116. When one graphics core 116 is enabled, that graphics core 116 has access to all of the memory bandwidth. In some configurations, it is possible for each graphics core 116 to access the entirety of the graphics processor memory 118. In some configurations, all of the components of the graphics processor 107 are included on a single die. In some implementations, each graphics core 116, the shared cache 140, the shared physical interface 142, the shared data fabric 144, the shared multimedia processor 146, and the graphics processor memory 118 have their own individually adjustable clock.

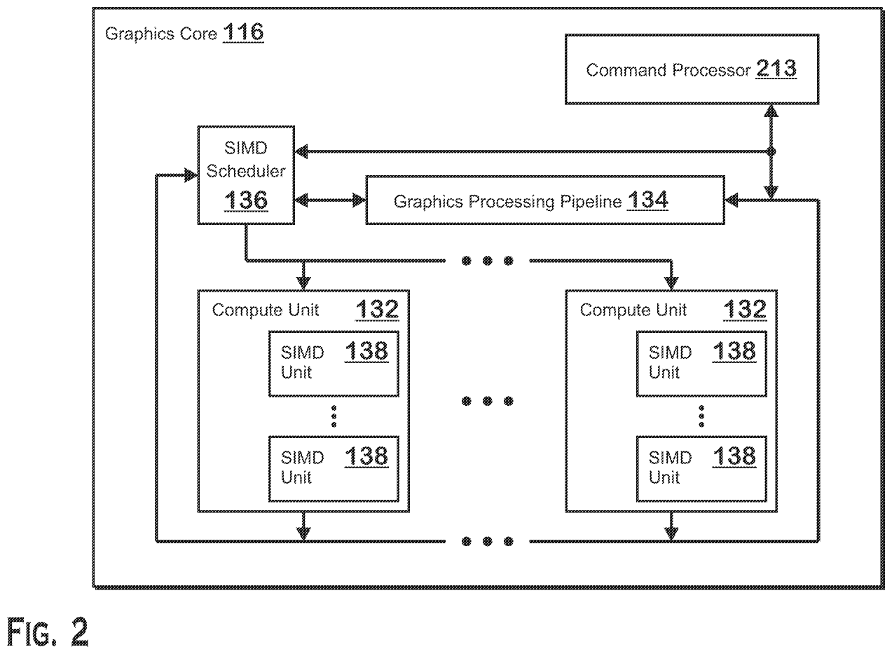

FIG. 2 is a block diagram illustrating details of a graphics core 116, according to an example. The graphics core 116 executes commands and programs for selected functions, such as graphics operations and non-graphics operations that may be suited for parallel processing. The graphics core 116 can be used for executing graphics pipeline operations such as pixel operations, geometric computations, and rendering an image to display device based on commands received from the processor 102. The graphics core 116 also executes compute processing operations that are not directly related to graphics operations, such as operations related to video, physics simulations, computational fluid dynamics, or other tasks, based on commands received from the processor 102. A command processor 213 accepts commands from the processor 102 (or another source), and delegates tasks associated with those commands to the various elements of the graphics core 116 such as the graphics processing pipeline 134 and the compute units 132.

The graphics core 116 includes compute units 132 that include one or more SIMD units 138 that are configured to perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. A scheduler 136 is configured to perform operations related to scheduling various workgroups and wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the graphics core 116 for execution.

As described elsewhere herein, the graphics processor 107 includes multiple graphics cores 116. Each graphics core 116 has its own command processor 213. Therefore, each graphics core 116 independently processes a command stream received from a guest VM 204 assigned to that graphics core 116. Thus, the operation of a particular graphics core 116 does not affect the operation of another graphics core 116. For example, if a graphics core 116 becomes unresponsive or experiences a stall or slowdown, that unresponsiveness, stall, or slowdown does not affect a different graphics core 116 within the same graphics processor 107.

The description herein describes the graphics cores 116 as being associated with, and used by, a single guest VM 204 in a virtualized computing scheme. However, it should be understood that other implementations are possible. More specifically, any implementation in which the server 103 includes multiple independent server-side entities, each of which communicates with a different client 105, each of which is associated with a particular graphics core 116, and each of which transmits command streams to the associated graphics core 116 and transmits the results of such command streams (e.g., pixels) to the associated client 105, falls within the scope of the present disclosure. Generically, such server-side entities are referred to herein as server applications. In some examples, one or more server applications are video games and the server 103 assigns each such video game a different graphics core 116 of the graphics processor 107.

In addition, the description herein describes the configuration of the graphics processor 107 as being controlled by a hypervisor 206. However, any other component (implemented as hardware, software, or a combination thereof) of the server 103 could alternatively control the configurations of the graphics processor 107. Generically, such component is referred to herein as the graphics processor configuration controller.

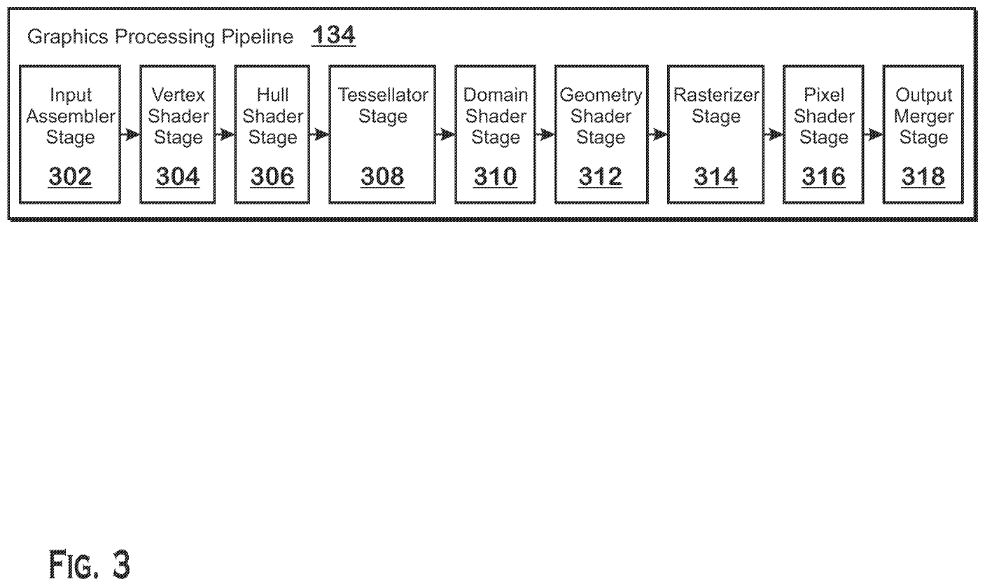

FIG. 3 is a block diagram showing additional details of the graphics processing pipeline 134 illustrated in FIG. 2. The graphics processing pipeline 134 includes stages that each performs specific functionality. The stages represent subdivisions of functionality of the graphics processing pipeline 134. Each stage is implemented partially or fully as shader programs executing in the compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the compute units 132 perform operations for the geometry shader stage 312.

The rasterizer stage 314 accepts and rasterizes simple primitives and generated upstream. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the compute units 132.

The output merger stage 318 accepts output from the pixel shader stage 316 and merges those outputs, performing operations such as z-testing and alpha blending to determine the final color for a screen pixel.

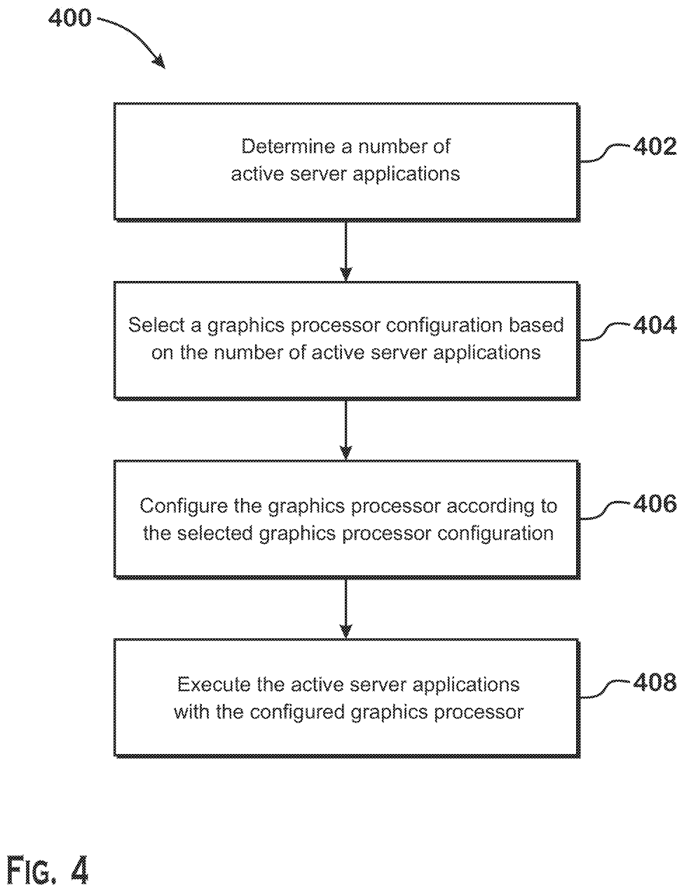

FIG. 4 is a flow diagram of a method 400 for operating a graphics processor 107 with multiple graphics cores 116, according to an example. Although described with respect to the system of FIGS. 1A-3, those of skill in the art will understand that any system, configured to perform the steps of the method 400 in any technically feasible order, falls within the scope of the present disclosure.

The method 400 begins at step 402, where a graphics processor configuration controller (such as the hypervisor 206) determines a number of active server applications (such as guest VMs 204). An active server application is a server application that is configured to request that work be performed by an associated graphics core 116. In some examples, the graphics processor configuration controller receives a request from another entity such as a workload scheduler for a cloud gaming system to configure the processor 102 to execute a certain number of active server applications and the same number of graphics cores 116 of the graphics processor 107. In various examples, this request is based on the number of clients 105 using the services of the cloud gaming system.

At step 404, the graphics processor configuration controller selects a graphics processor configuration based on the number of active server applications. In some examples, the graphics processor configuration controller is capable of varying the performance levels of one or more graphics cores 116 based on the number of active server applications and thus based on the number of active graphics cores 116. In some examples, graphics processor configurations differ in that, in configurations with fewer graphics cores 116 that are enabled, more of the available power and thermal budget is available for those fewer graphics cores 116 than in configurations with a greater number of graphics cores 116 enabled. Therefore, in configurations with fewer graphics cores 116 enabled, at least one graphics core is afforded a higher performance level than that same graphics core 116 is afforded in a graphics processor configuration with a greater number of graphics cores 116 enabled. In various examples, performance levels define one or more of the clock frequency of a graphics core 116, the amount of memory bandwidth available for the graphics core 116, the amount of memory or cache that is available for use by the graphics core 116, or other features that define the performance level of the graphics core 116.

At step 406, the graphics processor configuration controller configures the graphics processor 107 according to the selected graphics processor configuration. Specifically, the graphics processor configuration controller enables the graphics cores 116 that are deemed to be enabled according to the selected graphics processor configuration and sets the performance levels of each of the enabled graphics cores 116 according to the selected graphics processor configuration.

At step 408, the graphics processor configuration controller causes the active server applications to execute with the configured graphics processor 107. Executing a server application includes causing the server application to forward a stream of commands for processing by an associated graphics core 116 of the graphics processor 107. More specifically, as described elsewhere herein, each server application is assigned a particular graphics core 116. Each server application transmits a command stream to the graphics core 116 associated with that server application. In any particular graphics core 116, the command processor 213 of that graphics core executes that command stream to process commands and data through the graphics processing pipeline 134 and/or to process compute commands.

It should be understood that many variations are possible based on the disclosure herein. Although features and elements are described above in particular combinations, each feature or element can be used alone without the other features and elements or in various combinations with or without other features and elements. It should be understood that although the graphics cores 116 are described as including a graphics processing pipeline 134 that, in some implementations, includes fixed function components, a graphics core 116 with a graphics processing pipeline 134 fully implemented through shaders without fixed function hardware, or a graphics core 116 with general purpose compute capabilities but not graphics processing capabilities is contemplated herein. In other words, in the present disclosure, the graphics cores 116 may be substituted with graphics cores that do not include fixed function elements (and thus are implemented fully as programmable shader programs), or may be substituted with general purpose compute cores that include the compute units 132 but not the graphics processing pipeline 134 and can perform general purpose compute operations.

Any of the disclosed functional blocks are implementable as hard-wired circuitry, software executing on a processor, or a combination thereof. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for operating a processor that includes multiple cores, the method comprising:
determining a number of active applications, wherein each active application comprises an application executing on a second processor and each active application is configured to transmit commands to the processor for execution;
selecting a processor configuration for the processor based on the number of active applications, wherein the processor configuration includes one active core per active application;
configuring the processor according to the selected processor configuration; and
executing the active applications with the configured processor.

2. The method of claim 1, wherein the processor configuration indicates a number of active cores of the processor.

3. The method of claim 2, wherein the number of active cores is equal to the number of active applications.

4. The method of claim 1, wherein the processor configuration includes a performance level for the cores of the processor.

5. The method of claim 4, wherein the performance level indicates a clock frequency.

6. The method of claim 1, wherein the processor comprises a graphics processor.

7. The method of claim 6, wherein each core is a graphics core that includes a command processor and a graphics processing pipeline.

8. The method of claim 1, wherein the applications are server applications.

9. The method of claim 1, wherein each application executes on a different virtual machine.

10. A system for operating a processor that includes multiple cores, the system comprising:
the processor; and
a control processor configured to:
determine a number of active applications, wherein each active application comprises an application executing on a second processor and each active application is configured to transmit commands to the processor for execution;
select a processor configuration for the processor based on the number of active applications, wherein the processor configuration includes one active core per active application;
configure the processor according to the selected processor configuration; and
execute the active applications with the configured processor.

11. The system of claim 10, wherein the processor configuration indicates a number of active cores of the processor.

12. The system of claim 11, wherein the number of active cores is equal to the number of active applications.

13. The system of claim 10, wherein the processor configuration includes a performance level for the cores of the processor.

14. The system of claim 13, wherein the performance level indicates a clock frequency.

15. The system of claim 10, wherein the processor comprises a graphics processor.

16. The system of claim 15, wherein each core is a graphics core that includes a command processor and a graphics processing pipeline.

17. The system of claim 10, wherein the applications are server applications.

18. The system of claim 10, wherein each application executes on a different virtual machine.

19. A non-transitory computer-readable medium storing instructions that, when executed by a first processor, cause the first processor to operate a processor that includes multiple cores by:
determining a number of active applications, wherein each active application comprises an application executing on a second processor and each active application is configured to transmit commands to the processor for execution;
selecting a processor configuration for the processor based on the number of active applications, wherein the processor configuration includes one active core per active application;
configuring the processor according to the selected processor configuration; and
executing the active applications with the configured processor.

20. The non-transitory computer-readable medium of claim 19, wherein the processor configuration indicates a number of active cores of the processor.
